(19) United States
(12) Patent Application Publication
(10) Pub. No.: US 2014/0201626 A1
(43) Pub. Date: Jul. 17, 2014

(54) SOCIAL MEDIA HELPING USERS TO CONTRIBUTE, VALUE AND IDENTIFY THEIR CULTURE AND RACE WHILE CREATING GREATER INTER- AND INTRA-CULTURAL RELATIONSHIPS ON COMMON GROUNDS OF INTEREST

(71) Applicant: Tomveyi Komlan Bidamon, Doraville, GA (US)

(72) Inventor: Tomveyi Komlan Bidamon, Doraville, GA (US)

(21) Appl. No.: 14/155,331

(22) Filed: Jan. 14, 2014

Related U.S. Application Data
(60) Provisional application No. 61/752,336, filed on Jan. 14, 2013.

(51) Int. Cl. G06F 3/0482; G06F 17/30

(52) U.S. Cl. CPC G06F 3/0482; G06F 17/30595; G06F 17/30106
USPC 715/703

(57) ABSTRACT

A social media helps users to contribute, to value and to identify their race. The social media also helps users to develop and create a more racial friendship based on common interest points. The social media further allows users to share inspiring experiences and stories which can take written, photograph or video form. The social media can be used to create a visual memory for user's offspring and generations to come. By embracing one's race and culture while being open to understanding other people's race and culture, the social media can contribute to reduce or eliminate any psychological racial issue the world is facing.

### CROSS-REFERENCE TO RELATED APPLICATION

This application claims the benefit of priority of U.S. provisional application No. 61/752,336, filed Jan. 14, 2013, the contents of which are herein incorporated by reference.

### BACKGROUND OF THE INVENTION

The present invention relates to social media and, more particularly, to social media that helps users to contribute, value and identify their culture and race. The social media also helps users to develop and create greater inter- and intra-cultural relationships on common interest points. The social media can also be used to share inspiring experiences and stories which can be written as a book or made as a video, for example. The social media can be used to create a legacy as a visual memory for a user's generations to come.

Current social media have a deficiency in their ability to develop a more racial friendship and their ability to allow a greater easiness in communications within and outside one's own race. History, including current social media, fails to collect a visual memory of any single individual who has once lived on Earth. Current social media also lacks ability for users to provide inspirational stories or life experiences, especially as those may be related to one's own race or culture.

As can be seen, there is a need for social media that can allow users to develop inter-racial friendships on common grounds and interests while creating a virtual human race library as a legacy for generations to come.

### SUMMARY OF THE INVENTION

In one aspect of the present invention, a social media system comprises a social media site hosted by a hosting computer, the social media site having including a cultural values screen displaying various cultural values for various countries, the cultural values taken from profiles of users of the social media; a stories and experiences screen displaying various stories and experiences taken from profiles of users of the social media; an interests screen displaying various interests taken from a user of the social media; and a registry screen displaying interrelationships among other members related to the user of the social media; and a database storing user information entered into the social media.

These and other features, aspects and advantages of the present invention will become better understood with reference to the following drawings, description and claims.

### BRIEF DESCRIPTION OF THE DRAWINGS

FIG. 1 is a schematic representation of an exemplary screen shot of a main page of social media according to an embodiment of the present invention;

FIG. 2 is a schematic representation of an exemplary screen shot of a cultural values page of the social media of FIG. 1;

FIG. 3 is a schematic representation of an exemplary screen shot of a stories and experiences page of the social media of FIG. 1;

FIG. 4 is a schematic representation of an exemplary screen shot of an interests page of the social media of FIG. 1; and

FIG. 5 is a schematic representation of an exemplary screen shot of a registry page of the social media of FIG. 1.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides social media that helps users to contribute, to value and to identify their race. The social media also helps users to develop and create a more racial friendship based on common interest points. The social media further allows users to share inspiring experiences and stories which can take written, photograph or video form. The social media can be used to create a visual memory for user's offspring and generations to come. By embracing one's race and culture while being open to understanding other people's race and culture, the social media can contribute to reduce or eliminate any psychological racial issue the world is facing.

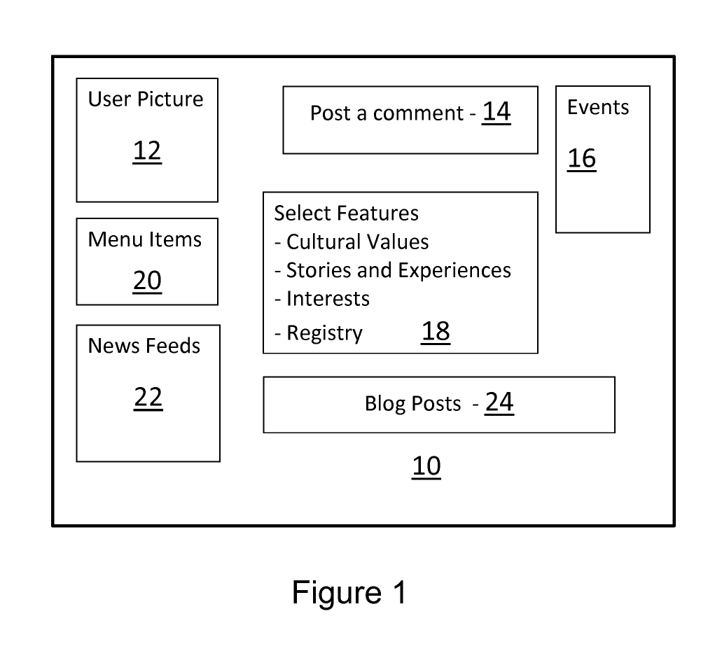

Referring now to FIG. 1, to access the social media, a user may connect, via a computing device connected to the internet, to a designated web site. In other embodiments, the user may connect to social media via a smartphone application, a computer software application, or the like. Once connected to the social media, the user may encounter a sign-in screen, which may allow a user to sign in. Also, on the sign-in screen, the user may be permitted to register for use of the social media as a new user. The user registration process can be used to identify the user, the user's race and culture and can allow the user to enter cultural values, experiences and stories, interests, family members, and the like. Of course, the user can enter these items at any time during use of the social media. Once the sign in screen is completed, the user may encounter a main screen 10, as shown in FIG. 1.

The main screen 10 can include various items, such as a user picture 12 and a place to post a comment 14. The user picture 12 may be a picture that the user chooses to associate with their social media profile. The comment 14 may be a comment regarding the user's current state of mind, what the user is doing, or the like. The main screen 10 can also include an events section 16, where current events may be posted. These events may be events highlighted by others or ones in which the user wishes to be reminded of in the events section 16. The main screen 10 can include news feeds 22 and selected blog posts 24 as well. The news feeds 22 and blog posts 24 can be determined by user preferences connected with their profile.

The main screen 10 can include a variety of menu items 20. The menu items 20 can include a link to the user's profile, a link to see the user's friends, a link to see the user's messages, albums, videos, apps, journal, forum, or the like.

The user can access their profile to enter their own cultural values, their own experiences and stories, their own interests and their own family members.

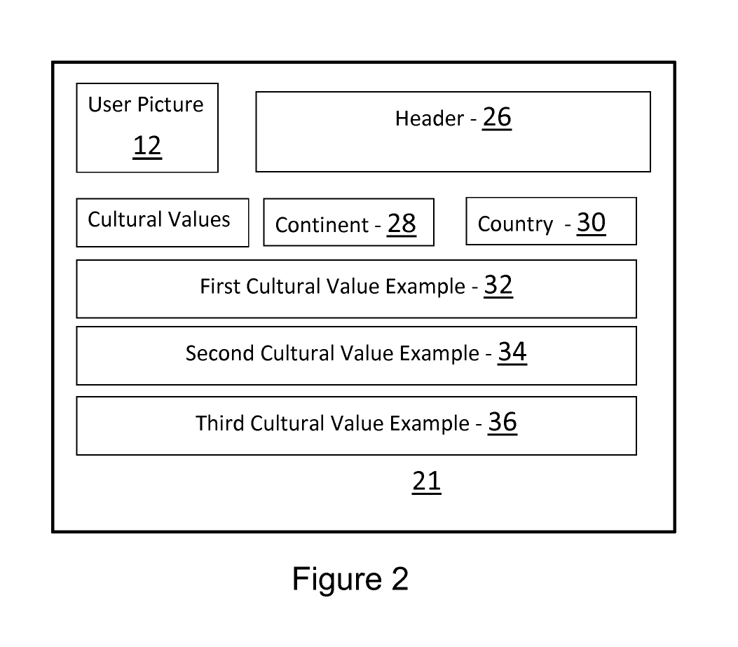

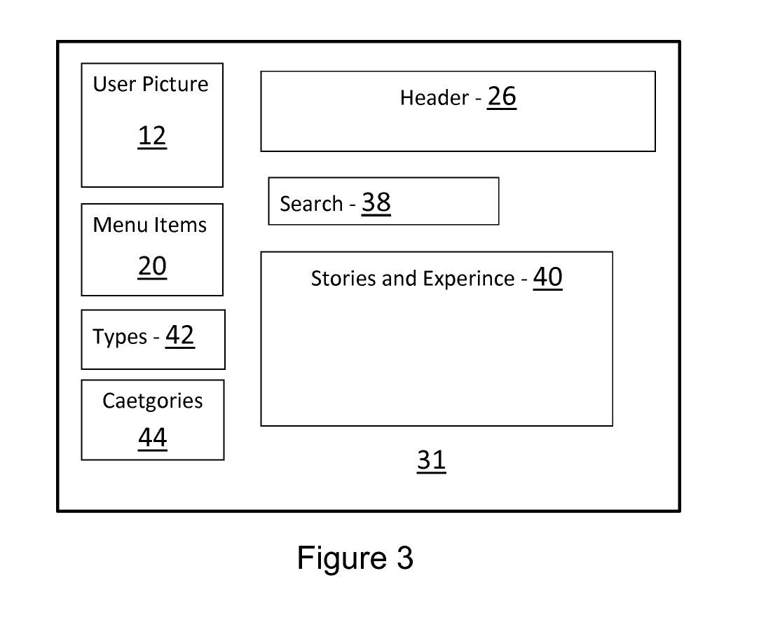

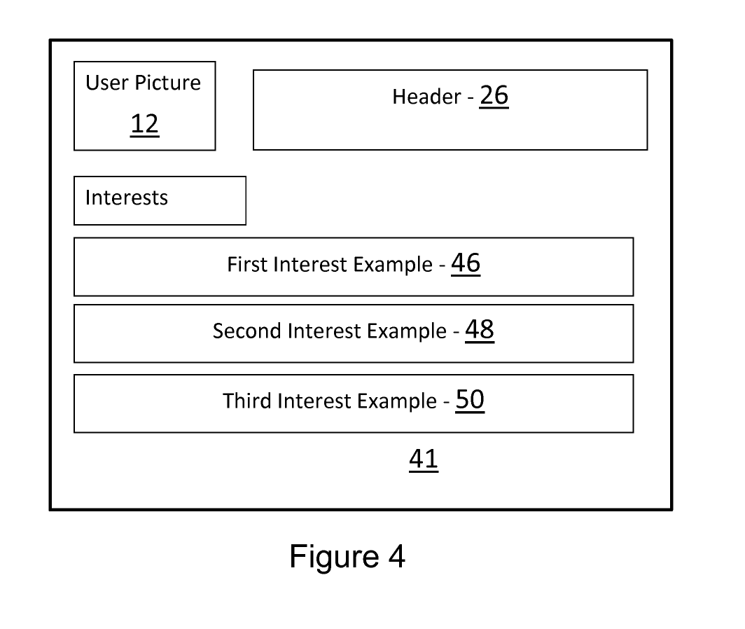

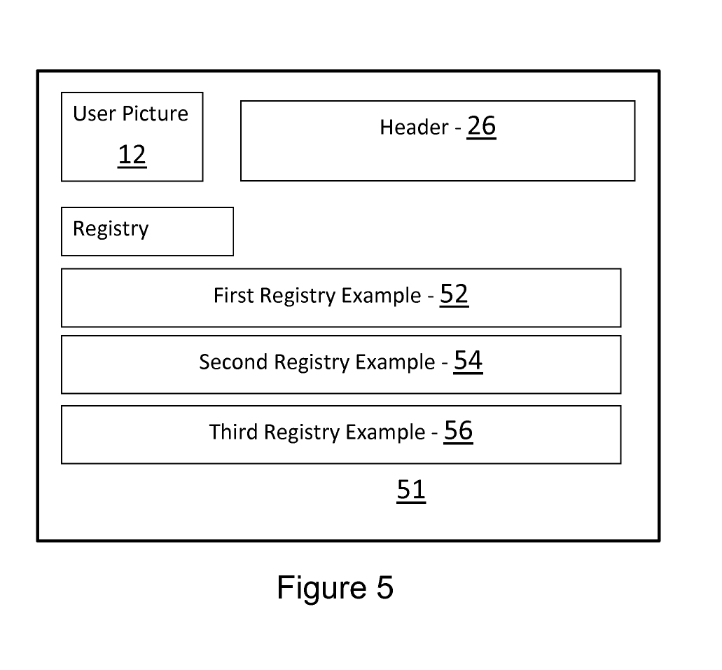

The main screen 10 can also include links to other screens in a select features section 18. The links can include a link to a cultural values screen (FIG. 2), a stories and experiences screen (FIG. 3), an interests screen (FIG. 4) and a registry screen (FIG. 5).

In some embodiments, the main screen 10 can also be customized by the user to change colors, sizes of various sections, or even to determine whether a particular section appears or not on a given screen. For example, a user can decide to not include their picture 12 on the main screen 10.

Referring now to FIG. 2, a cultural values screen 21 can be accessed from the main screen 10 by clicking on the appropriate link in the select features section 18. The cultural values screen 21 can include the user's picture 12 and a header 26, along with one or more cultural value examples 32, 34, 36. A user can select a specific continent 28 and/or country 30 from menu boxes, drop down boxes or the like. Once a country is selected, the one or more cultural value examples 32, 34, 36 can become populated. For example, the cultural value examples could include Food, Drink and Specialties, Rhythm and Dance, Sports, and the like.

Referring to FIG. 3, a stories and experience screen 31 can be accessed from the main screen 10 by clicking on the appropriate link in the select features section 18. The stories and experience screen 31 can include the user's picture 12 and a header 26, for example, as well as menu items 20, similar to those presented in the main screen 10. The user can type text into a search box 38 to search for stories and experiences, or the user can select stories and experiences from various types 42 and categories 44. A stories and experiences box 40 can display the desired stories and experiences. The types 42 can include inspired, funny or recommended stories and experiences, for example. The categories 44 can include business, educational and entertainment categories, for example.

Referring to FIG. 4, an interests screen 41 can be accessed from the main screen 10 by clicking on the appropriate link in the select features section 18. The interests screen 41 can include the user's picture 12 and a header 26, for example. The interests screen 41 can include one or more interests examples 46, 48, 50. For example, the interests screen 41 can include interests such as books, movies, sports, music, and the like.

Referring now to FIG. 5, a registry screen 51 can be accessed from the main screen 10 by clicking on the appropriate link in the select features section 18. The registry screen 51 can include the user's picture 12 and a header 26, for example. The registry screen 51 can include one or more registry examples 52, 54, 56. For example, the registry screen 51 can include family members, other relationships, and the like.

While the above Figures show three examples of interests, cultural values, interests, and registry items, any number of these examples can be provided on each screen. Also, while the figures show a header 26 and user picture 12 on each screen, these items may or may not be present, depending on the website design and/or the user's preferences.

As discussed above, the social media of the present invention may be accessed as an internet web site. The web site may be hosted by an appropriate server and stored in non-transitory computer readable media. The web site can be programmed in various languages and may include other features, menu items, and the like. A database can be used to store the data obtained from the users of the social media. The database can be searchable to provide a history of users as well as their culture and race.

It should be understood, of course, that the foregoing relates to exemplary embodiments of the invention and that modifications may be made without departing from the spirit and scope of the invention as set forth in the following claims.

What is claimed is:

1. A social media system comprising:
a social media site hosted by a hosting computer, the social media site having including:
a cultural values screen displaying various cultural values for various countries, the cultural values taken from profiles of users of the social media;
a stories and experiences screen displaying various stories and experiences taken from profiles of users of the social media;
an interests screen displaying various interests taken from a user of the social media; and
a registry screen displaying interrelationships among other members related to the user of the social media; and
a database storing user information entered into the social media.

2. The social media system of claim 1, wherein the cultural values screen includes one or more drop down menus to select a country from which the cultural values are displayed.

3. The social media system of claim 1, wherein the cultural values screen includes one or more cultural values examples.

4. The social media system of claim 3, wherein the one or more cultural values examples include food, drink and specialties; rhythm and dance; and sports.

5. The social media system of claim 1, wherein the stories and experience screen includes a search box to text search the stories and experiences stored in the database.

6. The social media system of claim 1, wherein the stories and experience screen include a types and categories section for selecting stories based on type and category.

7. The social media system of claim 6, wherein the types include and categories include inspired, funny and recommended stories and experiences and the categories include business, educational and entertainment categories.

8. The social media system of claim 1, wherein the interests screen include one or more interests examples for the user.

9. The social media system of claim 8, wherein the interests examples include books, movies, music, and sports.

10. The social media system of claim 1, wherein the registry screen includes one or more registry examples including family members and other relationships.
